(19) United States
(12) Patent Application Publication
(10) Pub. No.: US 2023/0190567 A1
(43) Pub. Date: Jun. 22, 2023

(54) GO ALONG STURDY WALKER

(71) Applicant: Pamela Hill-Williams, Sun Valley, CA (US)

(72) Inventor: Pamela Hill-Williams, Sun Valley, CA (US)

(21) Appl. No.: 17/555,354

(22) Filed: Dec. 17, 2021

(51) Int. Cl. A61H 3/04; A61G 5/10; A61G 5/12

(52) U.S. Cl. CPC A61H 3/04; A61G 5/1091; A61G 5/1035; A61G 5/1037; A61G 5/122; A61G 5/02

(57) ABSTRACT

An illustrated view of an exemplary walker device for a person necessitating the need of a walker and a wheelchair is presented. The walker device is light weight, foldable, provides contemporary conveniences and is cost efficient. The walker device can be further converted easily into a wheelchair.

### FIELD OF THE INVENTION

This invention relates to walkers. More particularly, it relates to a walker convertible into a wheelchair.

### BACKGROUND

A walker or walking frame is a tool for disabled or frail people, who need additional support to maintain balance or stability while walking, most commonly due to age-related physical restrictions.

The person walks with the frame surrounding their front and sides and their hands provide additional support by holding on to the top of the sides of the frame, Traditionally, a walker is picked up and placed a short distance ahead of the user. The user then walks to it and repeats the process. With the use of wheels and glides, the user may push the walker ahead as opposed to picking it up. This makes for easier use of the walker, as it does not require the user to use their arms to lift the walker. This is beneficial for those with little arm strength.

A walker is often used by those who are recuperating from leg or back injuries, it is also commonly used by persons having problems with walking or with mild balance problems.

Also related is a hemi-walker, a walker about half the size of a traditional walker which is intended for use by persons whose dexterity is limited or non-existent in one hand or arm. These walkers are more stable than a quad cane (a cane with four points that touch the ground, as opposed to one), but are not recommended as highly as a traditional walker for those who can use it.

A wheelchair is a chair with wheels, used when walking is difficult or impossible due to illness, injury, problems related to old age, or disability. These can include spinal cord injuries (paraplegia, hemiplegia, and quadriplegia), cerebral palsy, brain-injury, osteogenesis-imperfecta, motor-neuron-disease, multiple-sclerosis, muscular dystrophy, spina bifida, and more.

Wheelchairs come in a wide variety of formats to meet the specific needs of their users, They may include specialized seating adaptions, individualized controls, and may be specific to particular activities, as seen with sports wheelchairs and beach wheelchairs. The most widely recognized distinction is between motorized wheelchairs, where propulsion is provided by batteries and electric motors, and manual wheelchairs, where the propulsive force is provided either by the wheelchair user/occupant pushing the wheelchair by hand (“self-propelled”), by an attendant pushing from the rear using handle(s), or by an attendant pushing from the side use a handle attachment.

When a person needs to use a walker and a wheelchair, there are numerous issues that occur. A first of these issues is that two (2) devices are necessary, the walker and the wheelchair. This causes multiple issues; transportation requires the necessity to make space available for both devices and the weight of the wheelchair alone is overly burdensome to transport. A second of the issues is that when the person is walking using the walker, if the person becomes tired or is unable to continue to use the walker, the wheelchair is not readily available unless someone is bringing the wheelchair separately which is further burdensome and may not be necessary on a particular event.

Accordingly, and in light of the foregoing, it would be desirable to devise a device that can be useful as a walker and converted to a wheelchair upon need. It would be further advantageous if the device were light weight, foldable, provided contemporary conveniences and was cost efficient.

### BRIEF DESCRIPTION OF THE DRAWINGS

FIG. 1A is an illustrated view of an exemplary walker.

FIG. 1B is an illustrated view of handles of the walker shown in FIG. 1A.

FIG. 1C is an illustrated view of a tablet holder of the walker shown in FIG. 1A.

FIG. 1D is an illustrated view of a cellphone holder of the walker shown in FIG. 1A.

FIG. 1E is an illustrated view of a lower brace of the walker shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

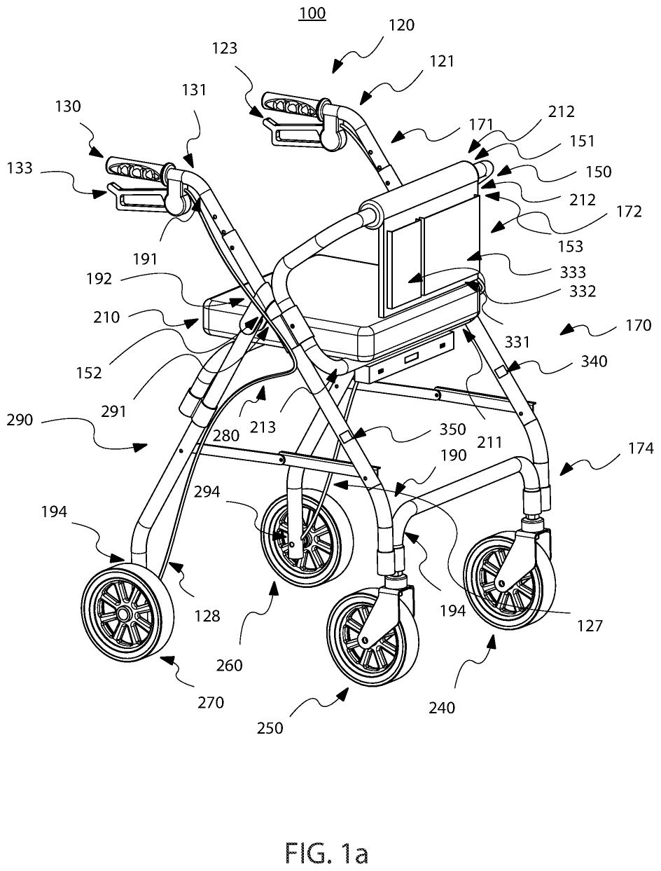

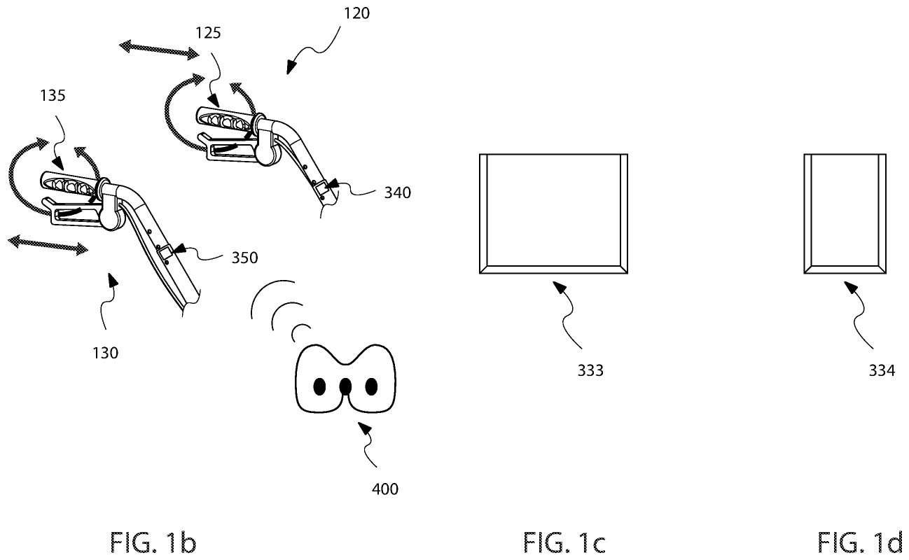

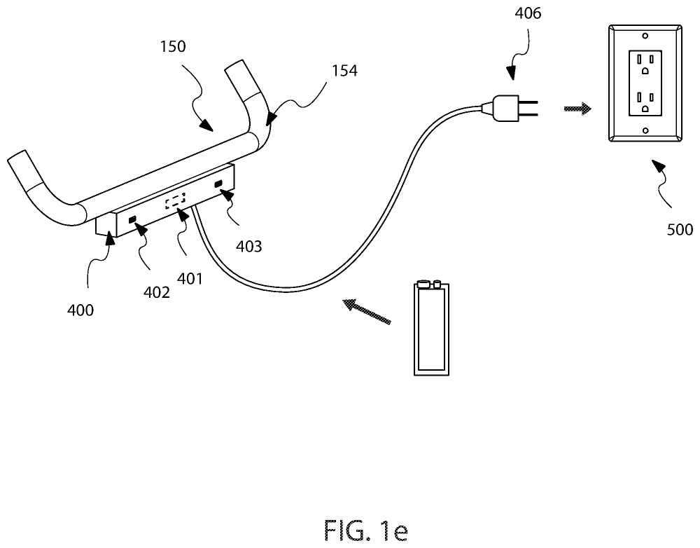

Referring to FIG. 1, an illustrated view of an exemplary walker device 100 for a person necessitating the need of a walker and a wheelchair is presented. The walker device 100 is light weight, foldable, provides contemporary conveniences and is cost efficient. The walker device 100 can be further converted easily into a wheelchair.

The walker device 100 is preferably made of an aluminum material, however other materials are hereby contemplated, including, but not limited to, poly-vinyl chloride (PVC), high-density polyethylene (HDPE), etc.

The walker device 100 has two (2) handles 120, 130, a backrest 150, two (2) front posts 170, 190, a seat 210, two (2) back posts 280, 290, and a plurality of wheels 240, 250, 260, 270. The front posts 280, 290 and the back posts 170, 190 are adjustable in height, such that the height may be no closer than four (4) inches from any of the wheels 240, 250, 260, 270.

A first end 121 of a first of the handles 120 is movably coupled to a first end 171 of a first of the two posts 170. A first end 131 of a second of the handles 130 is movably coupled to a first end 191 of a second of the two posts 190. Near a middle portion 172 of the first of the front posts 170 is coupled to a middle 281 of a first of the back posts 280. Near a middle portion 192 of the second of the front posts 190 is coupled to a middle 291 of a second of the back posts 290. Thereby, the front posts 170, 190 may be foldable with the back post 280, 290.

The first of the handles 120 and the second of the handles 130 each have a hand brake 123, 133. The hand brakes 123, 133 are useful for allowing the person to easily stop the walker device 100 without undue effort. The hand brakes 123, 133 preferably swing around each of their respective handles 120, 130 to allow for the hand brakes 123, 133 to be stored easily when not in use and to be in a comfortable position for the person when the walker device 100 is in use. A first of the hand brakes 123 is coupled to a third of the wheels 260 by a first cable 127. A second of the hand brakes 124 is coupled to a fourth of the wheels 270 by a second cable 128. The handles 120, 130 are shown in more detail in FIG. 1B.

A first side 211 of the seat 210 is coupled to the middle portion 281 of the first of the back post 280 near where the first of the back post 280 is coupled to the first of the front post 170. A second side 212 of the seat 210 is coupled to the middle portion 291 of the second of the back posts 290 near where the second of the back posts 290 is coupled to the second of the front posts 190. The seat 210 may be movable in an up and down method such that the seat 210 can be horizontal to accommodate a person sitting on the seat 210 and vertical such that the walker device 100 may be folded to a flat position.

A first end 151 of the backrest 150 is removably coupled to a top 282 of the first of the back post 280. A second end 152 of the backrest 150 is removably coupled to a top 292 of the second of the back post 290. The backrest 150 may have either the first end 151 or the second end 152 removed from the first back post 180 or the second back posts or both the first back post 180 and the second back post 190. The backrest 150 is swingable such that it can be folded into the front posts 280, 290 and the back posts 170, 190 to a flat condition. The backrest 150 is preferably padded, such that the person has comfort. The backrest 150 is shown in more detail in FIG. 1E.

A bottom 331 of a portable device holder 330 is coupled to a top 153 of the backrest 150. The portable device holder 330 has a table holder 332 and a cellphone holder 330. The tablet holder 332 is shown in more detail in FIG. 1C. The cellphone holder 333 is shown in more detail in FIG. 1D.

A first of the wheels 240 is movably coupled to a second end 174 of the first of the front posts 170. A second of the wheels 250 is movably coupled to a second end 194 of the second of the front posts 190. A third of the wheels 260 is movably coupled to a second end 284 of the first of the back posts 280. A fourth of the wheels 270 is movably coupled to a second end 294 of the second of the back posts 290.

Significantly near the second end 124, 135 of the back posts 120, 130 is a sensor 340, 350. The sensors 340, 350 may indicate a closeness of an object or human or may sense other data that can sent to a remote device or for a warning device (not shown).

Moving now to FIG. 1B, an illustrative view of the handles 120, 130 of the exemplary walker device 100 as shown in FIG. 1A is presented.

Each of the handles 120, 130 has a grip 125, 135. The grips 125, 135 allow for a comfortable grip on the handles 120, 130. The handles 120, 130 are telescopic in that the handles 120, 130 can be extended or retracted to a comfortable position for the person. The handles 120, 130 are further rotatable to position the handles 120, 130 to a comfortable and desirable position for the person using the walker device 100.

A global position system (GPS) remote 400 is communicatively coupled to the sensors 340, 350, such that the current location of the walker device 100 is traceable when the person using the walker device 100 cannot be otherwise located.

Now in FIG. 1C and FIG. 1D, an illustrated view of the tablet device holder 331 and the cellphone holder 332 is presented. Each of the tablet device holder 331 and the cellphone holder 333 have a recess 333, 334 such that a tablet or cellphone (neither shown) can be securely held when the walker device 100 is in motion. The table device holder 331 has a size consistent with the size of a computer tablet and the cellphone holder 332 has a size consistent with the size of a cellphone.

Referring now to FIG. 1E. an illustrated view of the backrest 150 is presented.

A back 154 of the backrest 150 has a charging panel 400. The charging panel 400 has a power supply 401 and one or more charging ports 402, 403. A first of the charging ports 402 is preferably a universal serial bus (USB) port, however the port may be other types of charging ports, such as, but not limited to, standard electrical plug-in port, a fire port, etc. A second of the charging ports 403 is preferably a universal serial bus (USB) port, however the port may be other types of charging ports, such as, but not limited to, standard electrical plug-in port, a fire port, etc.

The first of the charging ports 402 is preferably the same type of charging port as the second of the charging ports 403, however it is hereby contemplated that the first of the charging ports 402 and the second of the charging ports 403 are different types of charging ports.

The power source 401 is preferably an AC/DC power source 500, however other types of power sources are hereby contemplated, including, but not limited to, rechargeable battery 404, disposable battery, NiCad battery, etc. When the power source is an AC/DC power source 500, the charging panel 400 further has an electrical cord 405. The electrical cord 405 has an electrical plug 406 such that the electrical cord 405 can be coupled to the AC/DC power source 500.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A walker device for a person necessitating the need of a walker, the walker comprising:
two (2) handles, each of the handles having a first end and a second end, wherein the first end of each handle being coupled to one of the plurality of handles;
two (2) front posts, each of the handles having a first end, a second end and a middle portion, wherein the first end of each of the front posts being coupled to one of the handles;
two back posts, each of the back posts having a first end, a middle portion and a second end, wherein the middle of each of the two back posts being coupled to the middle portion of one of the front posts;
a backrest, the backrest having a first end, a second end and a top, wherein the first end of the backrest being coupled to the middle portion of a first of the back posts, and wherein the second end of the backrest being coupled to a second of the back posts;
a plurality of wheels, a first of the wheels being coupled to the second end of a first of the back posts, a second of the wheels being coupled to the second end of a second of the back posts, a third of the wheels being coupled to the second end of a first of the front posts, a fourth of the wheels being coupled to the second end of a second of the front posts; and
a seat, the seat having a first end and a second end, the first end of the seat being coupled to the middle portion of the first of the back posts, the second end of the seat being coupled to the middle portion of the second of the back posts.

2. The walker of claim 1, wherein the walker is made of an aluminum material.

3. The walker of claim 1, wherein the handle further comprises a grip.

4. The walker of claim 3, wherein the grip is rotatable.

5. The walker of claim 3, wherein the grip is telescopic.

6. The walker of claim 1, wherein a first of the hand brakes is coupled to the third of the wheels by a first cable.

7. The walker of claim 1, wherein a second of the hand brakes is coupled to the fourth of the wheels by a second cable.

8. The walker of claim 1, the backrest further comprising a charging panel, the charging panel being coupled to a back of the backrest.

9. The walker of claim 8, wherein the backrest further comprising a plurality of charging ports and a power supply.

10. The walker of claim 9, wherein the power supply is a electrical outlet, wherein the charging panel is coupled to the electrical panel by an electrical cord, the electrical cord has an electrical plug.

11. The walker of claim 8, wherein a first of the charging ports is a universal serial bus (USB) port.

12. The walker of claim 8, wherein a second of the charging ports is a universal serial bus (USB) port.

13. The walker of claim 1, wherein the first of the front post further comprises a first sensor.

14. The walker of claim 1, wherein the second of the front post further comprises a second sensor.
